(19) United States
(12) Patent Application Publication
(10) Pub. No.: US 2006/0208592 A1
(43) Pub. Date: Sep. 21, 2006

(54) Direct current planar motor

(75) Inventor: Hsiang-Chi Liu, Fengshan City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/124,096

(22) Filed: May 9, 2005

(30) Foreign Application Priority Data
Mar. 21, 2005 (TW) 94204332

(51) Int. Cl. H02K 37/00; H02K 21/12; H02K 3/04

(52) U.S. Cl. 310/156.35; 310/68 B; 310/207; 310/268

(57) ABSTRACT

A direct current planar motor is disclosed, comprising a rotor, at least a first stator and at least one second stator. The rotor can produce a multi-pole magnetic field with alternating polarity; the first stator having at least a first planar coil is parallelly arranged at a side of the rotor; and the second rotor having at least a second planar coil is parallelly arranged at another side of the rotor opposite to the first stator. Wherein the phase of the second planar coil is differed from that of the first planar coil by a specific phase, and a driving force is generated and exerted on the rotor for driving the same to rotate while the first stator and the second rotor are connected alternately. With the alternating of the connection to the first and the second stators, a dual-phase control is formed enabling the first and second planar coils to produce multi-pole magnetic fields with alternating polarity so as to enable the planar motor to be featured of ease-to-control, highly stable, and low-loading.

### 1. FIELD OF THE INVENTION

The present invention relates to a direct current motor, and more particularly, to a direct current planar motor that uses a dual phase drive control to achieve a multi-phase function.

### 2. BACKGROUND OF THE INVENTION

Miniaturization and high-performance is the future of modern motor design, whereas the precision formation technology fits the manufacture of micro motors. According to the report by a German marketing magazine, Nexus, the total revenue of the micro system produced using the precision formation technology is 30 billion US dollars at Year 2000, and is expected to grow up to 70 billion US dollars at Year 2005. These micro products include the optical pickup heads of optical disk drives, the ink-jet print heads of printers, pressure sensors, micro motors, and so on. Among those micro products, the penny motor will grow about 50 times within the five-year period and ranks No. 1 in growth among all micro products.

Since the penny motor, comparing to the other micro motors, is small in size and has excellent efficiency and performance, it is expected to replace the role of the motors of the current market in the near future after the technology for mass production has matured and the quality yield rate is increased to a specific level. As a result, the design of the product using the penny motor can become lighter and thinner.

However, the present penny motor such as a coreless planar penny motor disclosed in U.S. Pat. No. 4,349,761, entitled “Flat Type Coreless Rotary Electric Machine”, is coiled with an axial winding method, and such motor requires the installation of an electric brush and thus has a complicated mechanical structure. Since the motor is wound in the axial direction, therefore the thickness of the motor cannot be reduced significantly. Further, a planar motor wounded with a flexible printed circuit coil as disclosed in U.S. Pat. No. 4,645,961, entitled “Dynamoelectric Machine Having a large Magnetic Gap and Flexible Printed Circuit Phase Winding”, is driven by a multi-phase drive, and thus such motor has a complicated control.

In view of the foregoing shortcomings, a direct current planar motor is urgently needed to overcome the shortcomings of the prior arts.

### SUMMARY OF THE INVENTION

It is the primary object of the invention to provide a direct current planar motor, having stators with planar coil disposed on both sides of a rotor for producing a multi-pole magnetic field while the stators are connected to a direct current of a power supply, and thus driving the rotor to rotate.

Another object of the invention is to provide a direct current planar motor, capable of producing a multi-pole magnetic field with alternating polarity distribution by using a dual-phase direct current power source to control the stators thereof so as to enable the planar motor to be featured of ease-to-control, highly stable, and low-loading.

It is yet another object of the present invention to provide a direct current planar motor, having stators with a planar coil and a rotor capable of producing a multi-pole magnetic field, for enabling the products using the planar motor to become structural simplified, and thus lighter, thinner and smaller.

To achieve the foregoing objects, the present invention provides a direct current planar motor, comprising a rotor, at least a first stator and at least one second stator. The rotor can produce a multi-pole magnetic field with alternating polarity; the first stator having at least a first planar coil is parallelly arranged at a side of the rotor; and the second rotor having at least a second planar coil is parallelly arranged at another side of the rotor opposite to the first stator. Wherein the phase of the second planar coil is differed from that of the first planar coil by a specific phase difference, and a driving force is generated and exerted on the rotor for driving the same to rotate while the first stator and the second rotor are connected alternately. With the alternating of the connection to the first and the second stators, a dual-phase control is formed enabling the first and second planar coils to produce multi-pole magnetic fields with alternating polarity so as to enable the planar motor to be featured of ease-to-control, highly stable, and low-loading.

### BRIEF DESCRIPTION OF THE DRAWINGS

FIG. 1 is a schematic view of the assembly of a stator with a rotor of a direct current planar motor according to the present invention;

FIG. 2A is a schematic view of the distribution of magnetic poles of a rotor according to a preferred embodiment of the present invention;

FIG. 2B is a top view of the distribution of magnetic poles of a rotor according to another preferred embodiment of the present invention;

FIG. 3A is a direct current timing diagram of a direct current planar motor according to the present invention;

FIG. 3B is a schematic view of the distribution of planar coil magnetic fields of a direct current planar motor according to the present invention;

FIGS. 4A and 4B are schematic views of a planar coil according to a preferred embodiment of the present invention;

FIG. 5 is a schematic view of a direct current planar motor according to a preferred embodiment of the present invention;

FIG. 6A is a schematic view of connecting planar coils in series according to the present invention;

FIG. 6B is a schematic view of connecting planar coils in parallel according to the present invention;

FIG. 6C is a schematic view of a plurality of layers of stators according to the present invention;

FIG. 7A is a schematic view of a planar coil according to the present invention;

FIG. 7B is a schematic view of planar coils connected in parallel as depicted in FIG. 7A; and

FIG. 7C is a schematic view of planar coils connected in series as depicted in FIG. 7A.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

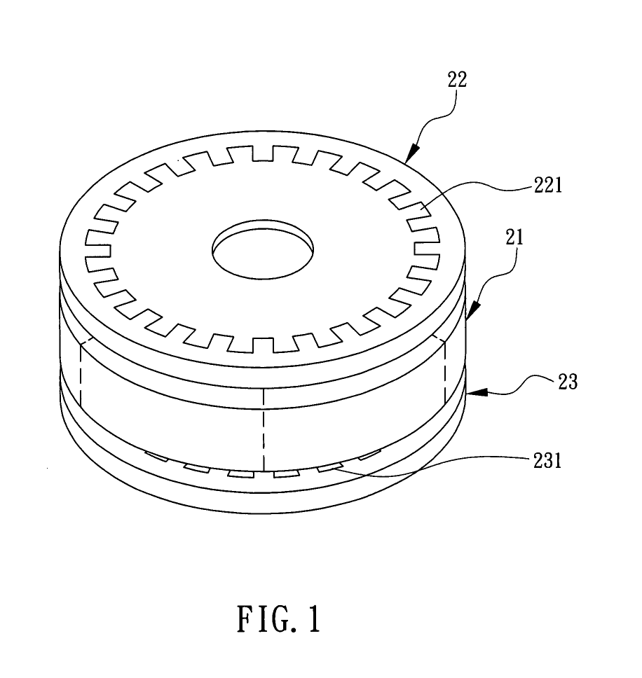

Referring to FIG. 1, a schematic view of the assembly of a stator with a rotor of a direct current planar motor of the present invention is illustrated. The assembly comprises a rotor 21, a first stator 22 and a second stator 23, wherein the rotor 21 can produce a multi-pole magnetic field of alternating polarity; the first stator 22 having a first planar coil 221 arranged thereon is parallelly disposed at a side of the rotor 21, and the first planar coil 221 is connected to a direct current of a power supply to produce a plurality of magnetic poles of alternating polarity, and the first planar coil 221 is wound in concentric circles around the periphery of the first stator 22 with the center of the first stator 22 as the center of the concentric circles. The second stator 23 is parallelly disposed at another side of the rotor 21 opposite to the first stator 22, and the second stator 23 has a second planar coil 231 arranged thereon which differs from the first planar coil 221 with a specific phase difference, and the second planar coil 231 is connected to a direct current power supply to produce a plurality of magnetic poles of alternating polarity, and the second planar coil 231 surrounds the periphery of the second stator 23 with the center of the second stator 23 as the center thereof.

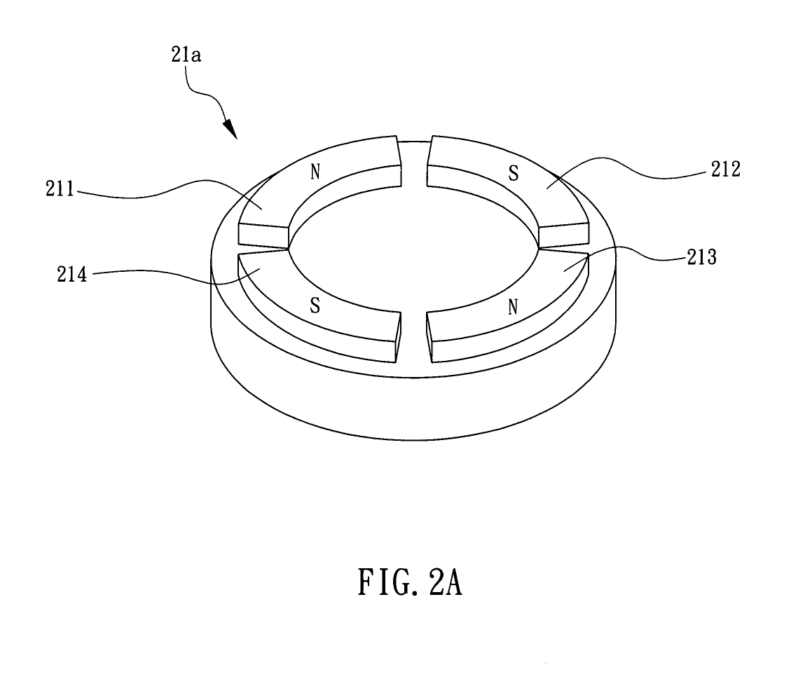

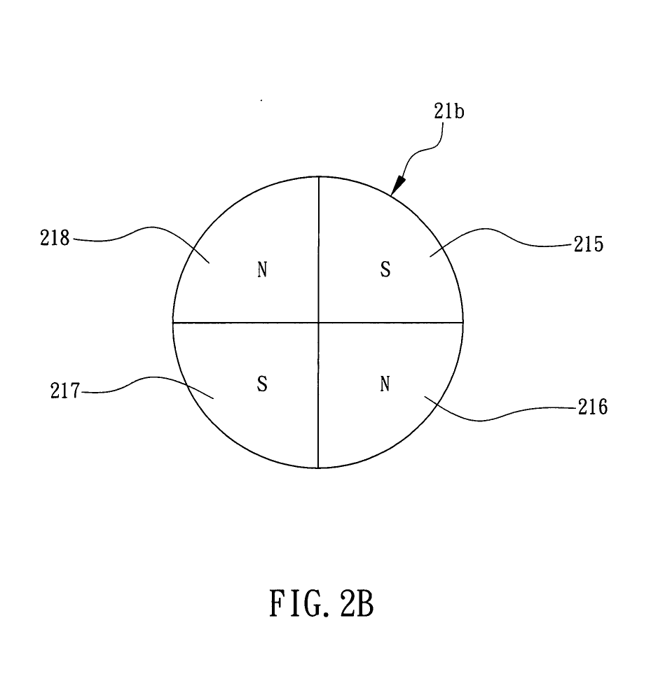

Referring to FIGS. 2A and 2B, schematic views of the distribution of magnetic poles of the rotor according to the present invention are illustrated. In the figures, the rotor produces the multi-pole magnetic field of alternating polarity by placing a plurality of magnetic poles in an manner of alternating polarity. In FIG. 2A, a multi-pole magnetic field of alternating polarity of the rotor according to a preferred embodiment of the present invention is illustrated. The rotor 21a has a plurality of N-pole magnets 211, 213 (two magnets are adopted in this embodiment) and a plurality of S-pole magnets 212, 214 (two magnets are adopted in this embodiment) attached on a lateral side 210 (this figure only shows one of the lateral sides facing the first stator 22, and it is the same to that facing the second stator 23) of the rotor 21a (as shown in FIG. 1), and the plurality of N-pole magnets and the plurality of S-pole magnets are alternating-distributed and disposed on the lateral side 210. The rotor 21a could be made of iron. In FIG. 2B, the rotor 21b is made of a multi-pole magnet, and the multi-pole magnet has a plurality of N-poles 216, 218 and a plurality of S-poles 215, 217 respectively disposed on the lateral side of the rotor 21b (as shown in FIG. 1), and the plurality of N-poles and the plurality of S-poles are alternating-distributed and disposed on the lateral side.

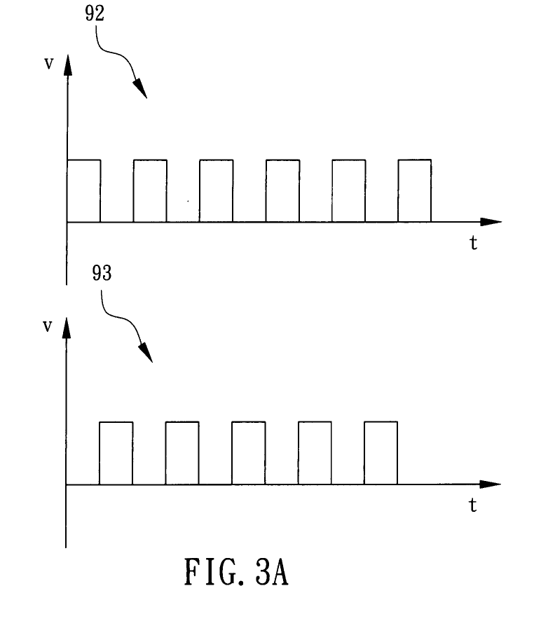

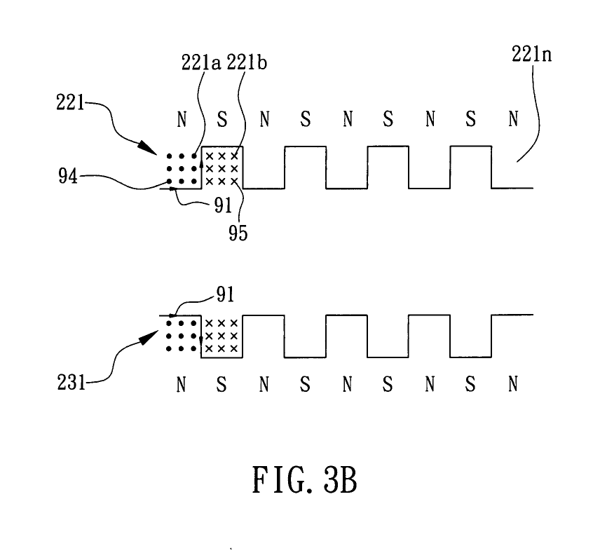

Referring to FIGS. 3A and 3B, a direct current timing diagram of a direct current planar motor of the present invention and a schematic view of the distribution of magnetic fields of a planar coil in the direct current planar motor of the present invention are illustrated respectively. In FIG. 3A, direct current timing diagrams 92, 93 show the direct current passing through the first planar coil 221 and the second planar coil 231 respectively. In FIG. 3B, the conductive wire of the first planar coil 221 is wound in a way forming a plurality of areas 221a˜221n. If a direct current passes through the first planar coil 221, Ampere's right hand rule is used to obtain the direction of the magnetic field produced by the change of magnetic flow (signals 94 indicates an outward flowing magnetic field and signal 95 indicates an inward flowing magnetic field). In this embodiment, the area 221a forms a N-pole magnetic field and the area 221b forms a S-pole magnetic field, and the direction of the magnetic field of other areas also can be obtained by Ampere's right hand rule.

Referring to FIGS. 3A and 3B, the principle for the movement of the rotor according to the present invention is illustrated. Since the direct current of a power supply 92 passes through the first planar coil 221 and the direct current of a power supply 93 passes through the second planar coil 231 has a timing difference (as shown in FIG. 3A), in addition to that the phase of the second planar coil is differed from that of the first planar coil by a specific phase difference which is 180 degrees in this embedment, a plurality of alternate magnetic fields distributed in the form of N-S-N-S . . . will be produced after the direct current of the power supply 92 passes through the first planar coil 221, and a plurality of magnetic fields distributed opposite to the magnetic fields of the first planar coil 221 and in the form of S-N-S-N is produced after the direct current of the power 93 passes through the second planar coil 231. Thus, a horizontal driving force is generated and exerted on the rotor when the direct current of the power supplies 92, 93 are applied alternately to the first planar coil 221 and the second planar coil 231, so as to drive the rotor 21 to rotate horizontally. The number of magnetic poles of the rotor 21 is not necessary to be matched with the number of magnetic poles produced by the first stator 22 and the second stator 23.

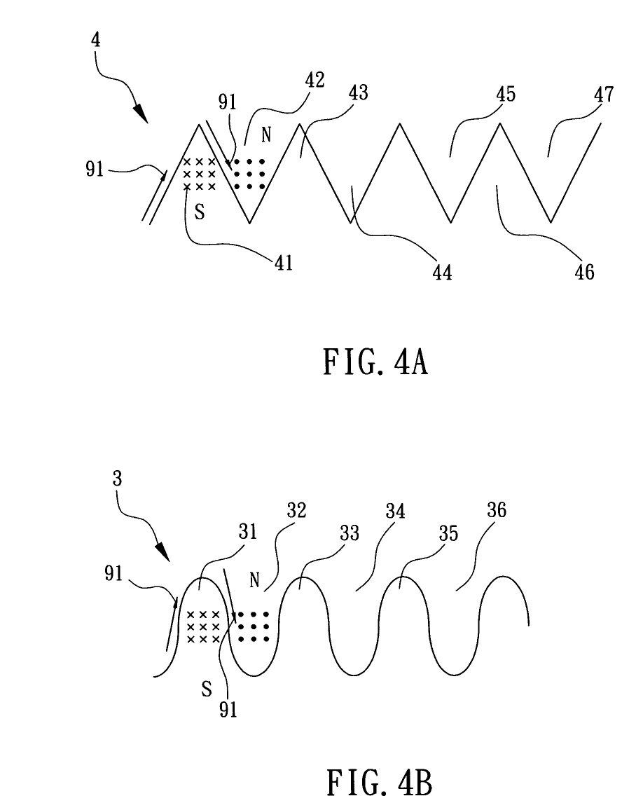

Referring to FIGS. 4A and 4B, schematic views of a planar coil according to another preferred embodiment of the present invention are illustrated. Since the planar coil of the invention primarily uses a conductive wire to define a plurality of areas, such that an alternate distribution of magnetic fields is produced when the direct current of the power supply passes through the planar coil. In FIG. 3B, the direct current planar motor according to another preferred embodiment of the present invention is wound with a coil in a square waveform. In FIG. 4A, the planar coil 4 is wound by a coil in a triangular waveform. In other words, a triangular waveform is used to produce a plurality of areas 41˜47, and then the direct current of the power supply 91 is passed to produce a plurality of alternate magnetic fields. FIG. 4B shows another preferred embodiment. In FIG. 4B, the planar coil 3 is wound by a coil with a sine waveform, and the coil with a sine waveform is used to produce a plurality of areas 31˜36, and then the direct current of the power supply is passed to produce a plurality of alternate magnetic fields.

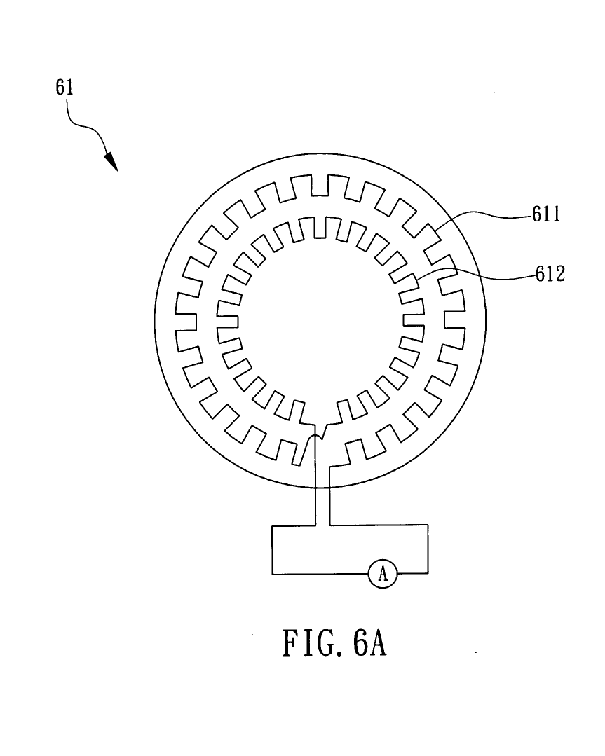

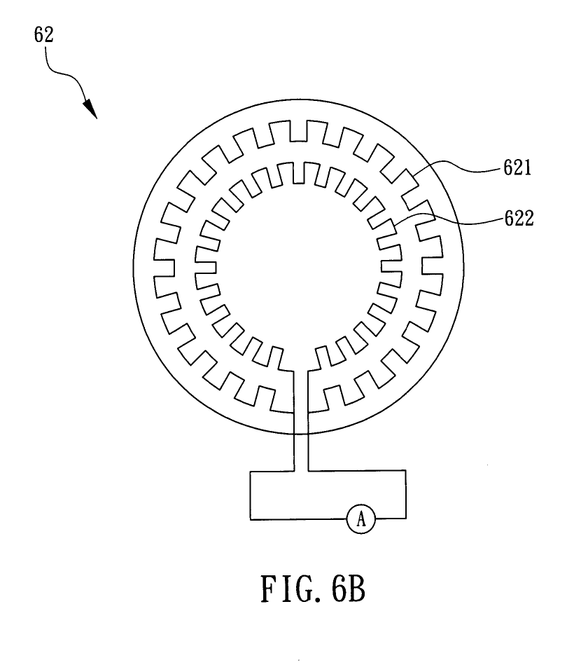

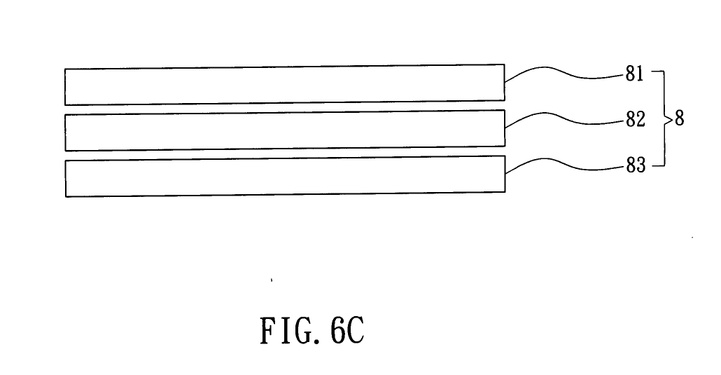

Referring to FIG. 6A, a schematic view of connecting planar coils connected in series according to the present invention is illustrated. The stator 61 of the present invention includes a plurality of planar coils 611, 612, 613 disposed around the stator 61 with the center of the stator 61 as the center. In FIG. 6A, the plurality of planar coils 611˜613 are electrically connected in series. Referring to FIG. 6B, the stator 62 of the present invention includes a plurality of planar coils 621, 622, 623 disposed around the stator 62 with the center of the stator 62 as the center. In FIG. 6B, the plurality of planar coils 621˜623 are electrically connected in parallel.

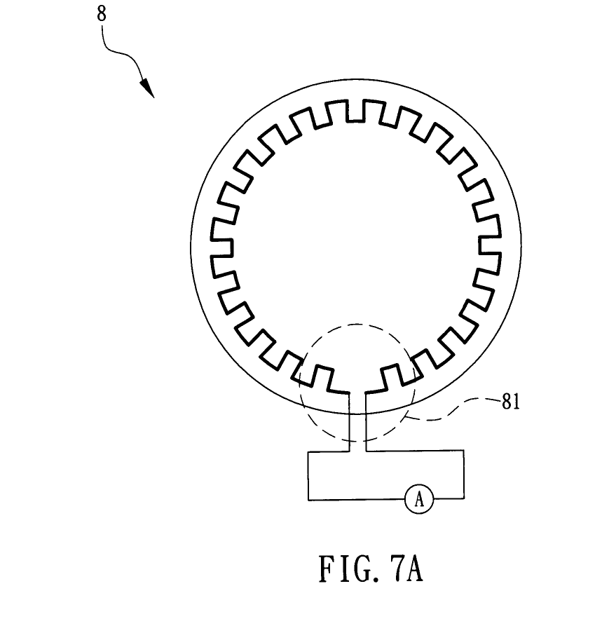

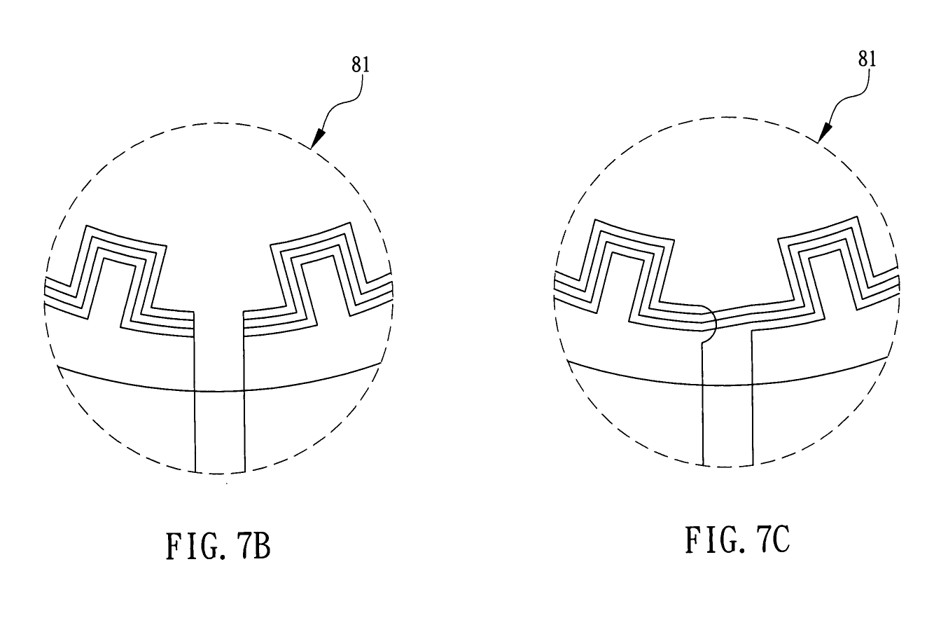

Referring to FIG. 6C, a schematic view of a plurality of layers of rotors according to the present invention. The present invention could stack a plurality of rotors 81, 82, 83 to define a stator 8 having a structure with a plurality of layers. Besides the aforementioned connection method, FIG. 7A also shows a planar coil according to another preferred embodiment of the present invention. In FIG. 7A, a plurality of coils are connected with each other, and the detail enlarged schematic views of the winding of the planar coils 8 are shown in FIGS. 7B and 7C. In FIG. 7B, the electric connection status 81 of the plurality of planar coils is connected in parallel. In FIG. 7C, the electric connection status 81 of the plurality of planar coils is connected in series.

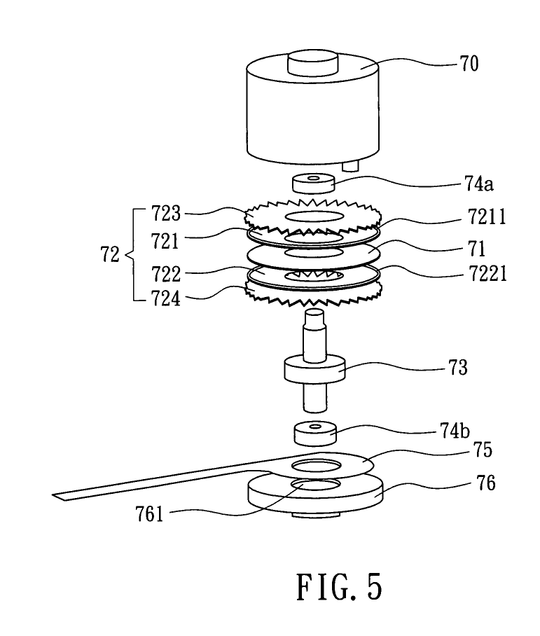

Referring to FIG. 5, a schematic view of a direct current planar motor according to a preferred embodiment of the present invention is illustrated. The direct current planar motor 7 comprises a casing 70, two axial layers 74a, 74b, a rotor 71, a stator 72, an axle 73, a circuit board 75 and a base 76 having a through hole 761. The casing 70 and the base 76 define a space for containing the two axial layers 74a, 74b, the rotor 71, the stator 72, the axle 73 and the circuit board 75. The rotor 71 can produce a multi-pole magnetic field of alternating polarity. The stator 72 includes a first stator 721 and a second stator 722, and the first stator 721 is installed parallel to a side of the rotor 71 and has a first planar coil 7211 disposed on the first stator 721. The first planar coil 7211 produces a plurality of alternate magnetic poles by passing a direct current power, and the first planar coil is wound into concentric circles with the center of the first stator 721 as the center of the concentric circles. To improve the permeability, a magnetic permeable plate 723 is installed onto a side of the first stator 721. The second stator 722 is installed parallel to another side of the rotor 71 and has a second planar coil 7221 with a phase difference with the first planar coil 7211 and disposed on the second stator 722. The second planar coil 7221 produces a plurality of alternate magnetic poles by passing a direct current power, wherein the phase difference is 180 degrees, and the second planar coil 7221 is wound into concentric circles with the center of the second stator 722 as the center of the concentric circles. To improve the permeability, a magnetic permeable plate 724 is installed onto a side of the first stator 721.

The axle 73 has a bearing 74a, 74b separately disposed on both ends of the axle 73, wherein the bearing 74a is installed at the center of the rotor 71 and the other bearing 74b is disposed in the through hole 761. The circuit board 75 is electrically connected with the first planar coil 7211 and the second planar coil 7221. The circuit board 75 further includes a control circuit for controlling the ON and OFF of a direct current passing through the first planar coil 7211 and the second planar coil 7221. The motor disclosed in the present invention uses a dual phase control to achieve the multi-pole performance and has the advantages of high efficiency, high stability of operation and low load by means of a simple dual phase control.

In summation of the description above, the present invention has the features of simple manufacture and easy installation, and thus it can meet the requirements of the industry and further improve the industrial competitiveness, and herein enhances the performance than the conventional structure and further complies with the patent application requirements and is submitted to the Patent and Trademark Office for review and granting of the commensurate patent rights.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A direct current planar motor, comprising:
a rotor, for producing a multi-pole magnetic field with alternating polarity;
at least one first stator, arranged parallel at a side of the rotor;
at least one first planar coil, installed on the first stator, capable of producing a plurality of magnetic poles with alternating polarity while a direct current of a power supply being conducted therethrough;
at least one second stator, arranged parallel at another side of the rotor opposite to the first stator; and
at least one second planar coil, installed on the second stator, capable of producing a plurality of magnetic poles with alternating polarity while the direct current of the power supply being conducted therethrough;
wherein, the phase of the second planar coil differs from that of the first planar coil by a specific phase difference.

2. The direct current planar motor of claim 1, wherein the specific phase difference is 180 degrees.

3. The direct current planar motor of claim 1, wherein the rotor is a multi-pole magnet having a plurality of N-poles and a plurality of S-poles alternating-distributed and disposed on the corresponding laterals thereof respectively facing the first stator and the second stator.

4. The direct current planar motor of claim 1, wherein the rotor comprises a plurality of N-pole magnets and a plurality of S-pole magnets alternating-distributed and attached onto the corresponding laterals thereof respectively facing the first stator and the second stator.

5. The direct current planar motor of claim 1, wherein the first planar coil is disposed on a lateral surface of the first stator circularly adopting the center of the first stator as the center of winding.

6. The direct current planar motor of claim 1, wherein the second planar coil is disposed on a lateral surface of the second stator circularly adopting the center of the second stator as the center of winding.

7. The direct current planar motor of claim 1, wherein the first planar coil further comprises a plurality of planar coils winding in concentric circles adopting the center of the first stator as the center of the concentric circles.

8. The direct current planar motor of claim 7, wherein the plurality of planar coils is connected in series.

9. The direct current planar motor of claim 7, wherein the plurality of planar coils is connected in parallel.

10. The direct current planar motor of claim 1, wherein the second planar coil further comprises a plurality of planar coils winding in concentric circles adopting the center of the second stator as the center of the concentric circles.

11. The direct current planar motor of claim 10, wherein the plurality of first planar coils is connected in series.

12. The direct current planar motor of claim 10, wherein the plurality of first planar coils is connected in parallel.

13. The direct current planar motor of claim 1, wherein the first planar coil is a coil selected from the group consisting of a square waveform coil, a sine waveform coil and a triangular waveform coil.

14. The direct current planar motor of claim 1, wherein the second planar coil is a coil selected from the group consisting of a square waveform coil, a sine waveform coil and a triangular waveform coil.

15. The direct current planar motor of claim 1, wherein the first rotor further comprises a bearing arranged at the center of the rotor.

16. The direct current planar motor of claim 1, further comprising a control circuit for selectively turning on and off a switch controlling the conduction of direct current to pass through the first planar coil and the second planar coil.

17. The direct current planar motor of claim 1, wherein the first stator includes a magnetic permeable plate.

18. The direct current planar motor of claim 1, wherein the second stator includes a magnetic permeable plate.

19. A direct current planar motor, comprising:
a rotor, for producing a multi-pole magnetic field with alternating polarity;
at least one first stator comprising a magnetic permeable plate, arranged parallel at a side of the rotor;
at least one first planar coil, installed on the first stator, capable of producing a plurality of magnetic poles with alternating polarity while a direct current of a power supply being conducted therethrough wherein the first planar coil further comprises a plurality of planar coils winding in concentric circles adopting the center of the first stator as the center of the concentric circles;
at least one second stator comprising a magnetic permeable plate, arranged parallel at another side of the rotor opposite to the first stator; and
at least one second planar coil, installed on the second stator, capable of producing a plurality of magnetic poles with alternating polarity while the direct current of the power supply being conducted therethrough wherein the second planar coil further comprises a plurality of planar coils winding in concentric circles adopting the center of the second stator as the center of the concentric circles;
wherein, the phase of the second planar coil differs from that of the first planar coil by a specific phase difference.

20. The direct current planar motor of claim 19, wherein the specific phase difference is 180 degrees.
